(19) United States
(12) Patent Application Publication
(10) Pub. No.: US 2023/0115687 A1
(43) Pub. Date: Apr. 13, 2023

(54) DURABLE BEARING STRUCTURE

(71) Applicant: Feng-Tien Chen, Taichung (TW)

(72) Inventor: Feng-Tien Chen, Taichung (TW)

(21) Appl. No.: 17/497,706

(22) Filed: Oct. 8, 2021

(51) Int. Cl. F16C 33/58; F16C 19/38

(52) U.S. Cl. CPC F16C 33/583; F16C 19/38; F16C 2223/10

(57) ABSTRACT

A bearing includes a ring unit including an outer ring and an inner ring. The inner ring is surrounded by the outer ring and shares a common axis. The outer ring includes at least one first recess, and the inner ring includes at least one second recess. Each of the at least one first recess and the at least one second recess is filled with a first durable material elements by way of welding. At least one roller unit including multiple rollers which rolls between the inner and outer rings. The rollers contact the multiple first durable material elements. The hardness of the multiple first durable material elements and the hardness of the rollers are higher than that of the ring unit so as to increase the life of use of the bearing and reduce manufacturing cost.

### BACKGROUND OF THE INVENTION

### 1. Fields of the Invention

The present invention relates to a bearing, and more particularly, to a durable bearing structure that has longer life of use.

### 2. Descriptions of Related Art

The conventional industrial bearings generally is made of stainless steel, medium carbon steel, Polytetrafluoroethene (PTFE), or Polyetheretherketone (PEEK). These material is less expensive and less durable so that the life of these bearings is short, and needs to be replaced frequently. This becomes a burden for recycling operations and is not friendly for environmental conservation. In heavy industrial equipment such as aerospace, high-speed railway, automobile industry, shipbuilding industry or wind power generation, large and super large bearings are used. In order to improve their durability, material with higher hardness is used to the bearings. Although it can increase the service life, in order to increase the hardness, it is necessary to add rare precious metals to the material. In addition to increasing the difficulty of metallurgy, it is also difficult to mold and cut due to its large size. Processing and grinding accuracy increase manufacturing time and high costs, which cannot be widely used and need to be improved.

The present invention intends to provide a durable bearing to eliminate shortcomings mentioned above.

### SUMMARY OF THE INVENTION

The present invention relates to a bearing that increases the life of use and reduces manufacturing cost.

The bearing of the present invention comprises a ring unit including an outer ring and an inner ring which is surrounded by the outer ring and shares a common axis with the outer ring. The outer ring includes a first face and at least one first recess is formed in the first face and extends along the peripheral direction of the outer ring. The first face is an annular face and faces the inner ring. The inner ring includes a second face and at least one second recess is formed in the second face and extends along the peripheral direction of the inner ring. The second face is an annular face and faces the outer ring. Each of the at least one first recess and the at least one second recess is filled with a first durable material elements by way of welding. At least one roller unit includes multiple rollers that rolls between the first and second faces. The rollers are located along the peripheral direction of the inner and outer rings and located at spaced intervals. The rollers contact the multiple first durable material elements. The hardness of the multiple first durable material elements and the hardness of the rollers are higher than that of the ring unit.

The advantages of the present invention are that the hardness of the multiple first durable material elements and the hardness of the rollers are higher than that of the ring unit. Each of the at least one first recess and the at least one second recess is filled with the first durable material elements element by way of welding. Therefore, the inner and outer rings are prevented from being worn by the rollers, and the life of use of the bearing is increased and the manufacturing cost is reduced accordingly. The lower frequency of replacement of the bearings also benefit to the environment.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the first embodiment of the bearing of the present invention;

FIG. 2 is a cross sectional view to show a derivative example of the first embodiment of the bearing of the present invention;

FIG. 3 is a cross sectional view to show the second embodiment of the bearing of the present invention;

FIGS. 4A to 4C respectively illustrate the cylindrical rollers used in the different derivative examples of the bearing of the present invention;

FIG. 5 is a cross sectional view to show the third embodiment of the bearing of the present invention;

FIG. 6 is a cross sectional view to show the fourth embodiment of the bearing of the present invention;

FIG. 7 is a cross sectional view to show the fifth embodiment of the bearing of the present invention;

FIGS. 8A to 8C respectively illustrate the truncated cone rollers used in the different derivative examples of the bearing of the present invention;

FIG. 9 is a cross sectional view to show the sixth embodiment of the bearing of the present invention;

FIG. 10 is a cross sectional view to show the seventh embodiment of the bearing of the present invention;

FIG. 11 is a cross sectional view to show a derivative example of the seventh embodiment of the bearing of the present invention;

FIG. 12 is a cross sectional view to show the eighth embodiment of the bearing of the present invention, and

FIG. 13 is a cross sectional view to show a derivative example of the eighth embodiment of the bearing of the present invention.

### DETAILED DESCRIPTION OF THE PREFERRED EMBODIMENT

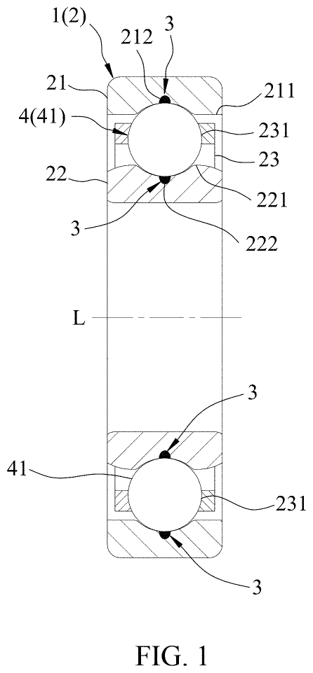

Referring to FIG. 1, the first embodiment of the bearing 1 of the present invention comprises a ring unit 2, multiple first durable material elements 3 and a roller unit 4. The ring unit 2 includes an outer ring 21 and an inner ring 22, wherein the inner ring 22 is surrounded by the outer ring 21 and shares a common axis “L” with the outer ring 21. A retainer 23 is located between the outer ring 21 and the inner ring 22. The outer ring 21 includes a first face 211 and a first recess 212 that is formed in the first face 211 and extends along the peripheral direction of the outer ring 21. The first face 211 is an annular face and faces the inner ring 22. The inner ring 22 includes a second face 221 and a second recess 222 that is formed in the second face 221 and extends along the peripheral direction of the inner ring 22. The second face 221 is an annular face and faces the outer ring 21. Each of the first and second recesses 212, 222 is filled with the first durable material elements element 3 by way of welding. The retainer 23 includes multiple rooms 231.

The roller unit 4 includes multiple rollers 41 that are received in the rooms 231 of the retainer 23 and roll between the first and second faces 211, 221. The rollers 41 of the first embodiment of the bearing 1 is balls which are located along the peripheral direction of the inner and outer rings 22, 21 and located at spaced intervals. The rollers 41 contact the multiple first durable material elements 3 in the retainer 23. The hardness of the multiple first durable material elements 3 and the hardness of the rollers 41 are higher than that of the ring unit 2. The ring unit 2 is made of medium carbon steel or stainless steel. The multiple durable material 3 and the rollers 4 are made of High Speed Steel (HSS), or other known high hardness material and is not limited thereto.

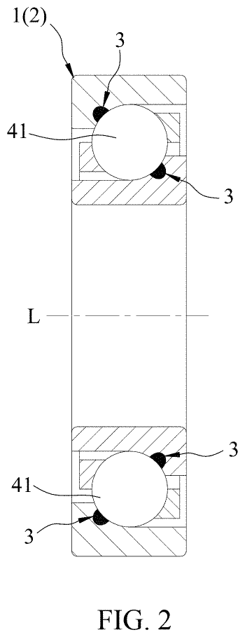

When the first durable material elements 3 is HSS, the HSS is welded to the first and second recesses 212, 222 to let the HSS have HRC65-70. Each roller 41 of the first embodiment of the bearing 1 is radially in contact with the ring unit 2. In a derivative example as shown in FIG. 2, each roller 41 is inclined located relative to the radial direction and contacts the ring unit 2, this type of bearing 1 is called angular bearing type. The outer ring 21 and the inner ring 22 of the ring unit 2 are relatively movable along the direction of the axis “L”, and this means that the bearing 1 bears the loads in radial direction and in axial direction.

The first durable material elements 3 is welded to the first and second recesses 212, 222 bearing 1 of the present invention, and the hardness of each of the first durable material elements 3 and the rollers 41 are higher than that of the outer ring 21 and the inner ring 22, so that the rollers 41 are prevented from being worn with the inner and outer rings 22, 21, and the lift of use is prolonged. In addition, the higher hardness material used to the first durable material elements 3 and the rollers 41 also reduce the use of precious metal. The life of use of the bearing 1 of the present invention is extended and longer than the conventional bearings, the difficulties for manufacturing for the ring unit 2 is reduced, and the manufacturing cost is reduced as well.

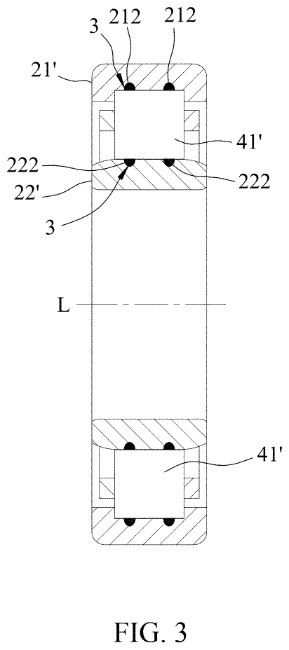

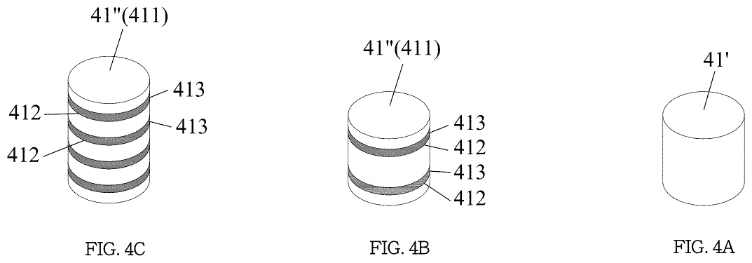

As shown in FIGS. 3 and 4A, the differences between the second embodiment and the first embodiment of the present invention are that the outer ring 21′ includes multiple first recesses 212 located at spaced intervals, and the inner ring 22′ includes multiple second recesses 222 located at spaced intervals. Each of the first and second recesses 212, 222 is filled with the first durable material elements 3 by way of welding. Each roller 41′ is a cylindrical roller. The second embodiment has the same functions and purposes as the first embodiment.

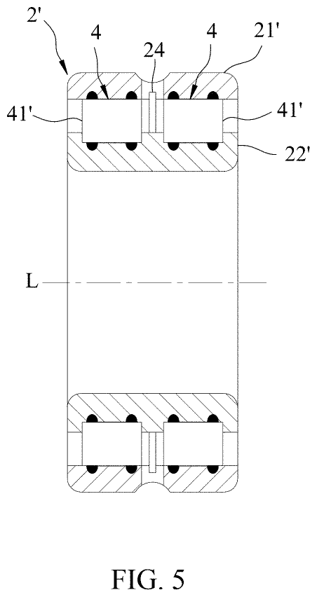

As shown in FIGS. 4A and 5, the differences between the third embodiment and the second embodiment of the present invention are that the bearing 1 of the third embodiment includes two roller units 4. The ring unit 2′ includes multiple clips 24 that are located between the roller units 4 and secure the outer ring 21 and the inner ring 22. By the two roller units 4 along the axis “L”, the third embodiment has the same functions and purposes as the second embodiment. The third embodiment of the bearing 1 bears higher radial loads.

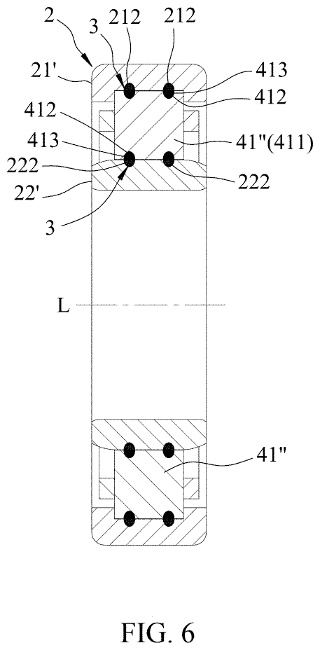

As shown in FIGS. 4B and 6, the differences between the fourth embodiment and the second embodiment of the present invention are that each of the rollers 41″ includes a roller element 411, and multiple annular grooves 412 are defined in the outer surface of each roller element 411. Each annular groove 412 is filled with a second durable material element 413 by way of welding. The hardness of the second durable material elements 413 is higher than the hardness of each of the roller elements 411. The second durable material elements 413 contacts the multiple durable material 3. The ring unit 2 and the rolling element 411 of each roller 41″ is made of medium carbon steel or stainless steel. The first durable material elements 3 and the second durable material elements 413 of each roller 41″ are made of High Speed Steel, or other known high hardness material and is not limited thereto. In the fourth embodiment, each roller 41″ includes two second durable material elements 413, however, in other embodiment, each roller 41″ may have only one second durable material element 413. As shown FIG. 4C, the roller 41″ includes more than two second durable material elements 413 so that the large-size rollers 41″ can bear lager load when compared with small-size rollers 41″. Simply by using high hardness material to the first and second durable material elements 3, 413, the fourth embodiment has the same functions and purposes as the second embodiment.

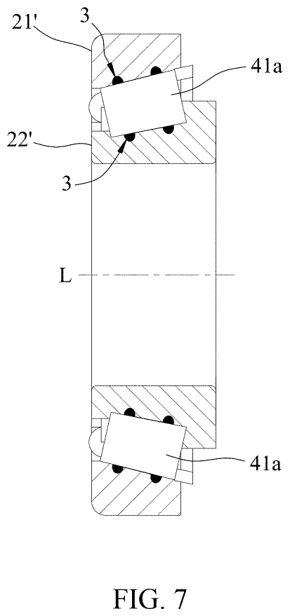

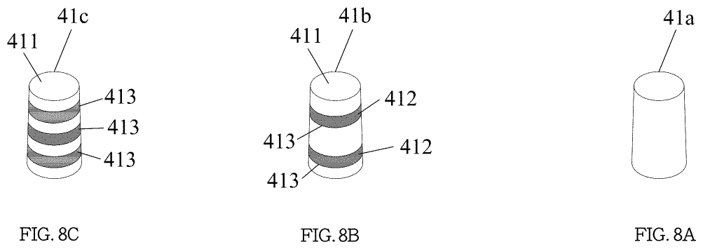

As shown in FIGS. 7 and 8A, the differences between the fifth embodiment and the second embodiment of the present invention are that the roller 41a of each roller unit 4 is a truncated cone roller. The fourth embodiment has the same functions and purposes as the second embodiment, and the fifth embodiment bears higher radial and axial loads.

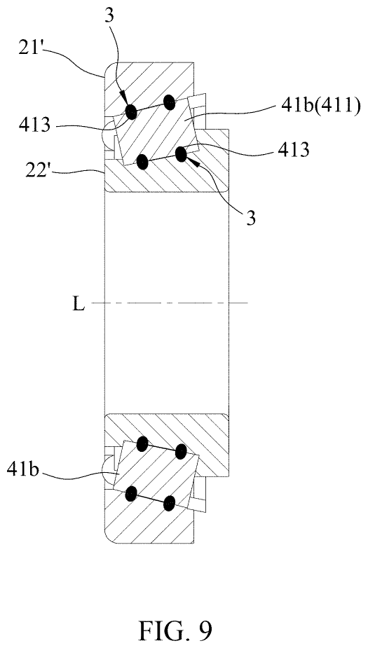

As shown in FIGS. 8B and 9, the differences between the sixth embodiment and the fifth embodiment of the present invention are that each of the rollers 41b includes a roller element 411, and multiple annular grooves 412 are defined in the outer surface of each roller element 411. Each annular groove 412 is filled with a second durable material element 413 by way of welding. The hardness of the second durable material elements 413 is higher than the hardness of each of the roller elements 411. The second durable material elements 413 contact the multiple first durable material elements 3. The ring unit 2 and the rolling element 411 of each roller 41b is made of medium carbon steel or stainless steel. The first durable material elements 3 and the second durable material elements 413 of each roller 41b are made of High Speed Steel, or other known high hardness material and is not limited thereto.

In the sixth embodiment, each roller 41b includes two second durable material elements 413, however, in other embodiment, each roller 41c may have three or more than three second durable material elements 413, as shown FIG. 8C.

By using harder material to the first durable material elements 3 and the second durable material elements 413, the sixth embodiment has the same functions and purposes as the fifth embodiment, and sixth embodiment has lower manufacturing cost.

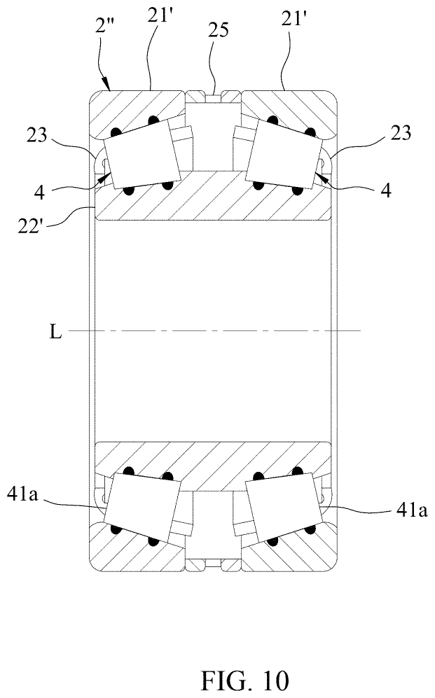

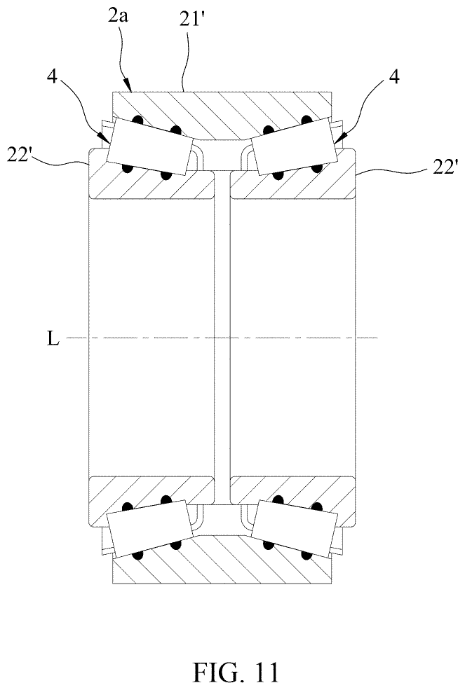

As shown in FIG. 10, the differences between the seventh embodiment and the fifth embodiment of the present invention are that the bearing 1 of the seventh embodiment includes two roller units 4 which are located along the axis “L” at spaced intervals. The ring unit 2″ includes two outer rings 21′ that are located along the axis “L” at spaced intervals, a separator 25 located between the two outer rings 21′, and two retainers 23 for the two roller units 4. In other derivative example, as shown in FIG. 11, the ring unit 2a includes two inner rings 22′ that are located along the axis “L”. By the roller units 4 along the axis “L”, the seventh embodiment has the same functions and purposes as the fifth embodiment. The seventh embodiment of the bearing 1 bears higher radial loads.

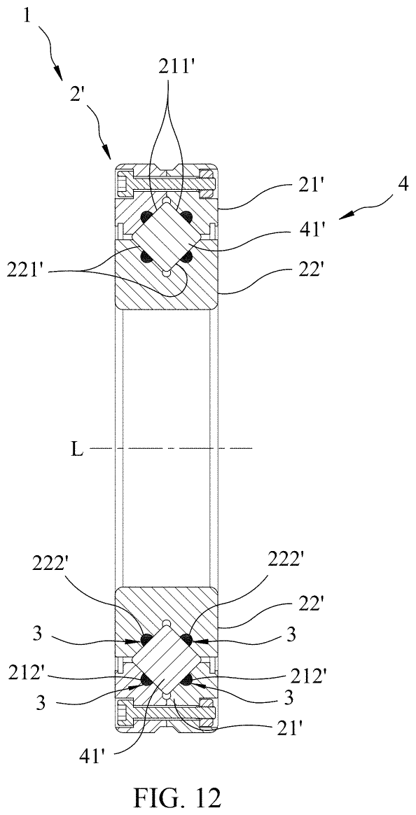

As shown in FIG. 12, the differences between the eighth embodiment and the second embodiment of the present invention are that the first face 211′ of the outer ring 21′ is an inverted V-shape face, and the second face 221′ of the inner ring 22′ is a V-shape face. The first and second faces 211′, 221′ form a parallelogram so that the rollers 41′ roll in the parallelogram. The parallelogram includes two first inclined faces located corresponding to the first face 211′, and two second inclined faces located corresponding to the second face 221′. Each of the two first inclined faces has the first recesses 212′. Each of the two second inclined faces has the second recesses 222′. The first recesses 212′ are located corresponding to the second recesses 222′. The first recesses 212′ and the second recesses 222′ are filled with the durable material 3. The rollers 41′ are cylindrical rollers, and the adjacent rollers 41′ are located in opposite directions so as to achieve the features of low speed, high load and no gap in the back.

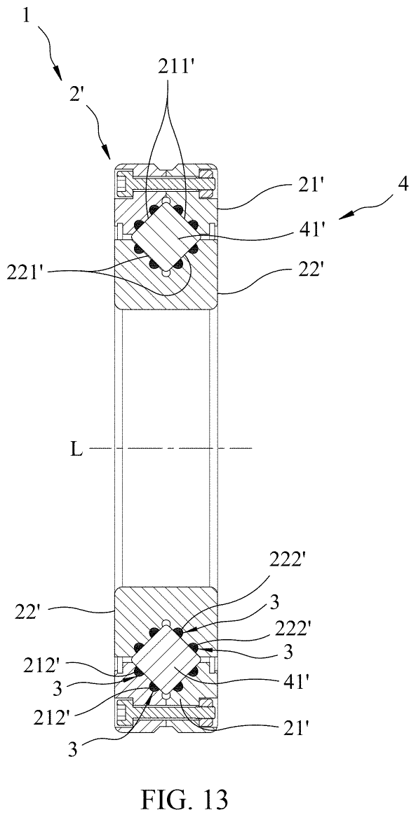

As shown in FIG. 13 which illustrate a derivative example of the eighth embodiment, the differences from the eighth embodiment are that each first inclined of the first face 211′ of the inverted V-shape face includes multiple first recesses 212′ located at spaced intervals. Each second inclined of the second face 221′ of the V-shape face includes multiple second recesses 222′ located at spaced intervals.

While we have shown and described the embodiment in accordance with the present invention, it should be clear to those skilled in the art that further embodiments may be made without departing from the scope of the present invention.

What is claimed is:

1. A bearing comprising:
a ring unit including an outer ring and an inner ring, the inner ring being surrounded by the outer ring and sharing a common axis with the outer ring, the outer ring including a first face and at least one first recess that is formed in the first face and extends along a peripheral direction of the outer ring, the first face being an annular face and facing the inner ring, the inner ring including a second face and at least one second recess that is formed in the second face and extends along a peripheral direction of the inner ring, the second face being an annular face and facing the outer ring;
multiple first durable material elements being respectively welded to the at least one first recess and the at least one second recess respectively, and
at least one roller unit including multiple rollers that roll between the first and second faces, the rollers located along the peripheral direction of the inner and outer rings and located at spaced intervals, the rollers contacting the multiple first durable material elements, a hardness of the multiple first durable material elements and a hardness of the rollers being higher than that of the ring unit.

2. The bearing as claimed in claim 1, wherein the ring unit is made of medium carbon steel or stainless steel, the multiple durable material and the rollers are made of High Speed Steel.

3. The bearing as claimed in claim 1, wherein each of the rollers includes a roller element, at least one annular groove is defined in an outer surface of each roller element, at least one second durable material element is welded to the at least one annular groove of each roller element, a hardness of the at least one second durable material element is higher than a hardness of each of the roller elements, the at least one second durable material element contacts the multiple durable material.

4. The bearing as claimed in claim 3, wherein the ring unit and each of the roller elements is made of medium carbon steel or stainless steel, the ring unit and each of the roller elements is made of High Speed Steel.

5. The bearing as claimed in claim 1, wherein each of the rollers is one of a ball, a cylindrical roller and a truncated cone roller.

6. The bearing as claimed in claim 1, wherein the ring unit includes a retainer which is located between the outer ring and the inner ring, the retainer includes multiple rooms in which the rollers are received.

7. The bearing as claimed in claim 1, wherein there are two roller units in the bearing, the two roller units are located along the axis and spaced from each other.

8. The bearing as claimed in claim 1, wherein there are two roller units in the bearing, the two roller units are located along the axis in a mirror-image arrangement, each roller is a truncated cone roller.

9. The bearing as claimed in claim 1, wherein the first face of the outer ring is an inverted V-shape face, the second face of the inner ring is a V-shape face, the first and second faces form a parallelogram so that the rollers roll in the parallelogram, the parallelogram includes two first inclined faces located corresponding to the first face, and two second inclined faces located corresponding to the second face, each of the two first inclined faces has the at least one first recesses, each of the two second inclined faces has the at least one second recesses, the first recesses are located corresponding to the second recesses, the first recesses and the second recesses are filled with the multiple durable material, the rollers adjacent to each other are located in opposite directions.
